(19) United States
(12) Patent Application Publication
(10) Pub. No.: US 2004/0195237 A1
(43) Pub. Date: Oct. 7, 2004

(54) Method and apparatus to provide a customized covering for an electrical outlet

(76) Inventors: Michael Shotey, Scottsdale, AZ (US); Marcus Shotey, Scottsdale, AZ (US); John Kinnard, Queen Creek, AZ (US)

Correspondence Address: SCHMEISER OLSEN & WATTS, 18 E UNIVERSITY DRIVE, SUITE # 101, MESA, AZ, 85201

(21) Appl. No.: 10/441,957

(22) Filed: May 20, 2003

Related U.S. Application Data
(60) Provisional application No. 60/460,210, filed on Apr. 4, 2003.

(51) Int. Cl. H02G 3/08

(52) U.S. Cl. 220/3.2

(57) ABSTRACT

The stock keeping units (SKU's) associated with electrical outlet cover assemblies may be reduced and the appearance of an electrical outlet cover assembly may easily be customized with a permanent or detachable lid cover that may interlock with or attach to the lid of an electrical outlet cover assembly. The lid cover may be rigid or it may be cut and shaped from a suitable material. A lid cover stencil may be provided to facilitate the formation of a non-rigid lid cover. The lid cover may further be applied to the cover assembly in a liquid state and allowed to harden or dry.

### BACKGROUND OF THE INVENTION

This disclosure relates generally to electrical outlets, and more particularly but not exclusively, to coverings for electrical outlets.

Assemblies that cover electrical outlets help to prevent inadvertent access to the electrically conductive elements of the outlets and hide unattractive wiring. Cover assemblies may further selectively lock to secure access to the enclosed electrical devices. Electrical outlets are employed both for indoor or outdoor weatherproof wiring; with respect to outdoor wiring, a cover assembly helps protect the outlet from rain, dirt, and dust.

Cover assemblies differ in configuration (for instance, size or shape). For example, a given outlet may be wired to electric sockets, both standard and ground fault current interrupts; light switches, both toggle and rocker plates; and cable television, telephone ports, or other telecommunication devices. Different cover assembly configurations support different shaped plugs or outlets with multiple electrical sockets, such as duplex electrical sockets.

Cover assemblies also differ in their stylistic characteristics, including materials, colors, and finishes. Different styles of cover assemblies exist, in part, to accommodate individualized preferences of a consumer, or to match an installed cover assembly to an adjacent structure.

The problem exists that to provide cover assemblies with different styles, a supplier of electrical parts must carry multiple cover assemblies for each cover assembly configuration. The supplier must track multiple SKU's, one for each style of cover assembly. As the variety of materials, colors, and finishes for cover assemblies increases, so do the SKU's and so does the shelf space and inventory required to stock the different styles of cover assemblies. Corresponding increases occur in the labor associated with ordering and handling different styles of cover assemblies. The prior art therefore does not solve the problem of having to order, stock and carry cover assemblies of the same configuration that differ in material, color or finish, as well as in their SKU.

The object of this invention is to provide a cover assembly that allows a cover assembly to be styled in accordance with individual preferences. A further object of this invention is to simplify purchasing decisions for cover assemblies. Yet another object of this invention is to reduce Stock Keeping Units (SKU's). Correspondingly, another object of this invention is to reduce shelf-space requirements for stocking and displaying cover assemblies. These objectives are achieved with the several embodiments described below and in the accompanying claims and drawing.

### BRIEF SUMMARY OF THE INVENTION

The present invention is a method and apparatus for customizing the appearance of an electrical outlet cover assembly and for reducing the stock keeping units (SKU's) associated with the marketing of electrical outlet cover assemblies. The apparatus may include a base and a lid. Also provided are a plurality of lid covers that are capable of attaching to or interlocking with the lid so as to change the appearance of the device. While the lid of the cover assembly may be of a suitable style (material, finish, or color), the lid cover may be of an alternate style. Interlocking the lid cover with the lid of the cover assembly may thereby change the appearance of the cover assembly from the style of lid to the style of the lid cover.

The lid cover may be molded, formed, shaped, cut and attached to or interlocked with the cover assembly. The lid cover may attach to the cover assembly in any detachable or permanent manner, including any of various known interlocking devices, including snap fingers, female tapered thread fittings with corresponding male threads, as well as any of various known adhering processes, such as spray-on plastics. The lid cover may also be a second lid that may be interchanged with the lid of the cover assembly. The lid cover may attach to the base of the cover assembly in lieu of the lid. The lid cover may alternatively exist in a liquid state that may be applied to the lid of the cover assembly with a brush, spray device, or other device, and which may dry or harden to a solid form after application.

### BRIEF DESCRIPTION OF THE SEVERAL VIEWS OF THE DRAWING

Non-limiting and non-exhaustive embodiments of the present invention are described with reference to the following figures, wherein like reference numerals refer to like parts throughout the various views unless otherwise specified.

FIG. 1 is a perspective view of a first embodiment of the present invention, illustrating a lid cover and an electrical outlet cover assembly.

FIG. 2 is a side view of a first embodiment of the present invention, illustrating a lid cover attached to a lid of a cover assembly installed onto an electrical outlet.

FIG. 3 is a perspective view of a first embodiment of the present invention, illustrating a lid cover.

FIG. 4 is an enlarged view of a first embodiment of the present invention, illustrating a portion of a lid cover.

FIG. 5 is a perspective view of a first embodiment of the present invention, illustrating a lid cover attached to the lid of a cover assembly.

FIG. 6 is an enlarged view of a first embodiment of the present invention that illustrates a portion of a lid cover attached to a portion of the lid of a cover assembly.

FIG. 7 is a perspective view of a first embodiment of the present invention, illustrating a lid cover and the lid of a cover assembly.

FIG. 8 is a perspective view of a first embodiment of the present invention, illustrating a lid cover attached to the lid of a cover assembly.

FIG. 9 is a perspective view of a first embodiment of the present invention, illustrating multiple lid covers and an electrical outlet cover assembly.

FIG. 10 is a side view of a first embodiment of the present invention, illustrating multiple lid covers stacked over and packaged with an electrical outlet cover assembly.

FIG. 11 is a perspective view of a second embodiment of the present invention, illustrating multiple interchangeable lids and the base of an electrical outlet cover assembly.

FIG. 12 is a side view of a second embodiment of the present invention, illustrating multiple interchangeable lids nested together and packaged with the base of an electrical outlet cover assembly.

FIG. 13 is a bottom view of a third embodiment of the present invention, illustrating a lid cover.

FIG. 14 is a perspective view of a third embodiment of the present invention, illustrating a lid for an electrical outlet cover assembly.

FIG. 15 is a bottom view of a fourth embodiment of the present invention, illustrating a lid cover.

FIG. 16 is a perspective view of a fourth embodiment of the present invention, illustrating a lid for an electrical outlet cover assembly.

FIG. 17 is a bottom view of a fifth embodiment of the present invention, illustrating a lid cover.

FIG. 18 is a perspective view of a fifth embodiment of the present invention, illustrating a lid for an electrical outlet cover assembly.

FIG. 19 is a top view of a sixth embodiment of the present invention, illustrating a lid cover stencil for a lid cover.

### DETAILED DESCRIPTION OF THE INVENTION

Set forth below is a description of what are currently believed to be the preferred embodiments or best examples of the invention claimed. Future and present alternatives and modifications to the preferred embodiments are contemplated. Any alternates or modifications in which insubstantial changes in function, in purpose, in structure or in result are intended to be covered by the claims of this patent.

Embodiments of systems, methods, and devices for providing a customized appearance for an electrical outlet cover assembly are described herein. Illustrated embodiments of the invention include a lid cover that is interchangeable with lid covers of differing styles (differing materials, colors, or finishes) to facilitate customizing the appearance of an electrical outlet cover assembly. Numerous styles of lid covers may be packaged together with an electrical outlet cover assembly to offer the consumer a choice of cover assembly appearance, while facilitating purchasing, ordering and stocking decisions.

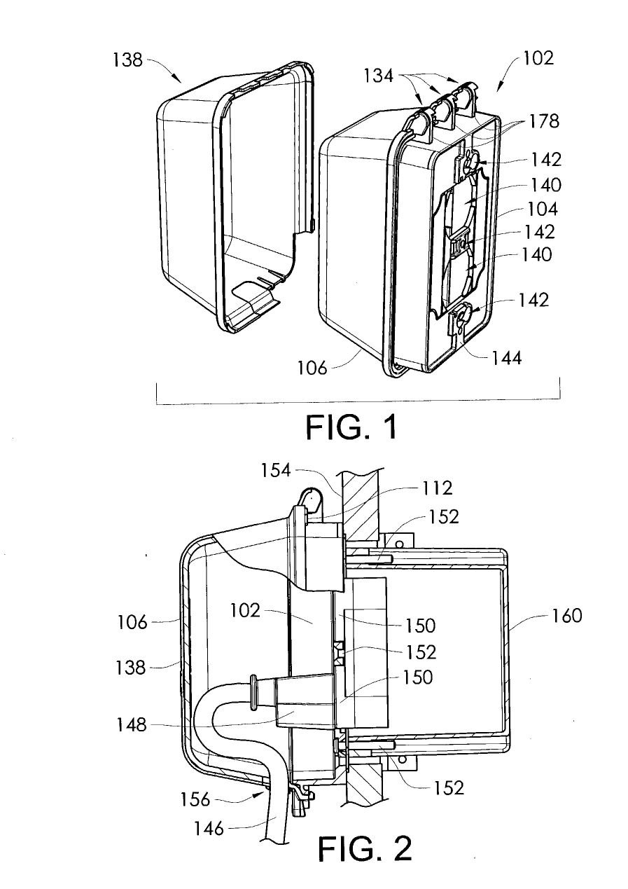

Referring now to FIG. 1, a first embodiment of the present invention is illustrated and shows a lid cover 138 and an electrical outlet cover assembly 102. Electrical outlet cover assembly 102 may include a base 104 and a lid 106. Base 104, lid 106 and lid cover 138 may each be of a material that is waterproof and corrosion-resistant, such as a thermoplastic or a cast metal. Lid cover 138 may more generally be any shape and dimension that substantially encloses the exterior of lid 106, when lid cover 138 and lid 106 are attached or interlocked together. Base 104 and lid 106 may be connected together by hinges 134. A set of hinges 134 are shown on the top of cover assembly 102, but may alternatively be located on any other side of cover assembly 102.

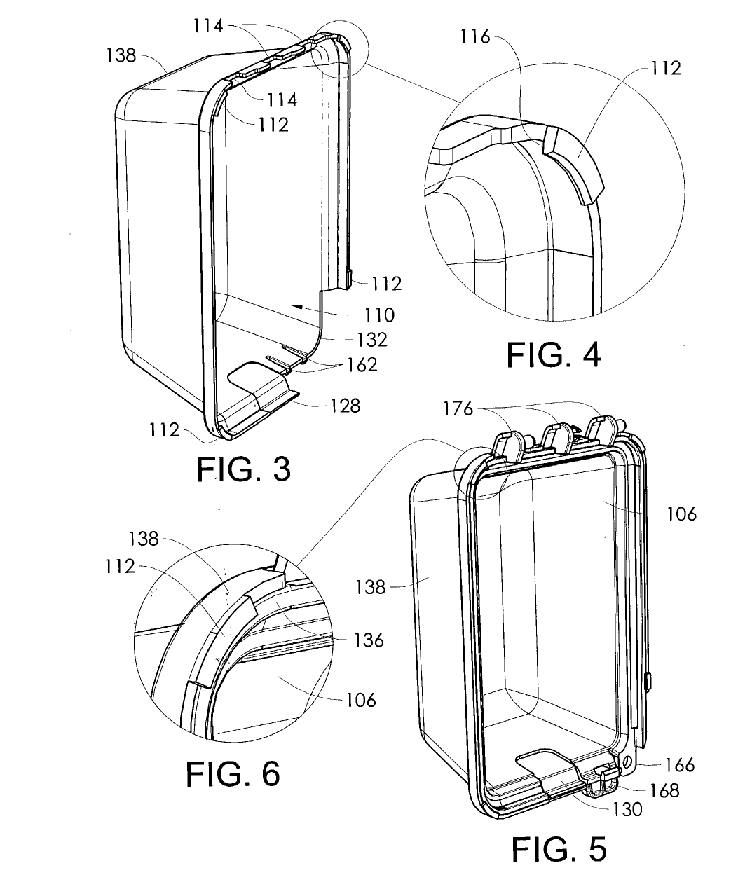

Referring now also to FIG. 2, the first embodiment of the present invention is further illustrated to show lid cover 138 interlocked over cover assembly 102, which is installed onto an electrical outlet box. Lid cover 138 may be of a substantially similar shape and dimension as lid 106 so as to permit lid cover 138 and lid 106 to nest together and cover a substantial portion of lid 106 as shown in FIGS. 3-6. The mechanism that permits lid cover 138 to interlock with lid 106 may include snap fingers 112 on lid cover 138, which engage the rim 136 of lid 106. When lid cover 138 is interlocked with lid 106, the style of lid cover 138 is visible and the style of lid 106 is substantially hidden. The style characteristics (material, color, or finish) of cover assembly 102 may thereby be customized to the style characteristics of lid cover 138.

Cover assembly 102 may be installed onto an electrical outlet box 160 with one or more fasteners, such as screws 152. Cover assembly 102 may be suitably shaped to provide sufficient clearance for electrical device components such as plug 148 and electrical cord 146.

Referring to both FIGS. 1 and 2, base planar portion 144 of base 104 may resemble a standard electrical outlet cover plate that may include one or more apertures 140 that are adapted to accommodate an electrical device such as electrical sockets 150. Also included are one or more apertures 142 that are adapted to accommodate fastening devices, such as screws 152. The fastening devices allow cover assembly 102 to be releasably secured to an electrical outlet box 160 or adjacent structure 154, as shown in FIG. 2.

Referring also to FIGS. 3, 4, 5, and 6, a first embodiment of the present invention is further illustrated. FIG. 3 more particularly shows components of lid cover 138 that may include a receptacle or aperture 110 of suitable shape to fit over and cover lid 106, or more generally to cover at least a portion of cover assembly 102. FIG. 5 illustrates a lid cover 138 and lid 106 that are releasably interlocked together. FIGS. 4 and 6 are enlarged views of a portion of FIGS. 3 and 5, respectively.

Lid cover 138 may further include one or more hinge clearance slots 114 that correspond to the locations of hinges 134 on cover assembly 102. Hinge clearance slots 114 in FIG. 3 correspond in location on lid cover 138 to the hinge halves 176 illustrated on FIG. 5. Hinge clearance slots 114 allow lid cover 138 to extend below the height of the hinges, thereby allowing the style of lid cover 138 to more completely replace the style of lid 106 (and in general of cover assembly 102).

Lid cover 138 may further include one or more interlocking devices capable to allow lid cover 138 to interlock with lid 106. For example, one interlocking arrangement that may be used are snap fingers 112 which permit lid cover 138 to interlock with lid 106. As shown in FIGS. 4 and 6, each snap finger 112 may include a flat engagement portion 116 capable to hook over the rim 136 of cover 106.

Lid cover 138 may further include a removable porthole tab 128 that may correspond in position to a removable porthole tab 130 on lid 106 to form a matching set. Referring also again to FIG. 2, to create porthole 156 through which an electrical cord 146 may extend, lid cover porthole tab 128 and lid porthole tab 130 may be removed. Cord 146 extends through porthole 156 to the exterior of cover assembly 102.

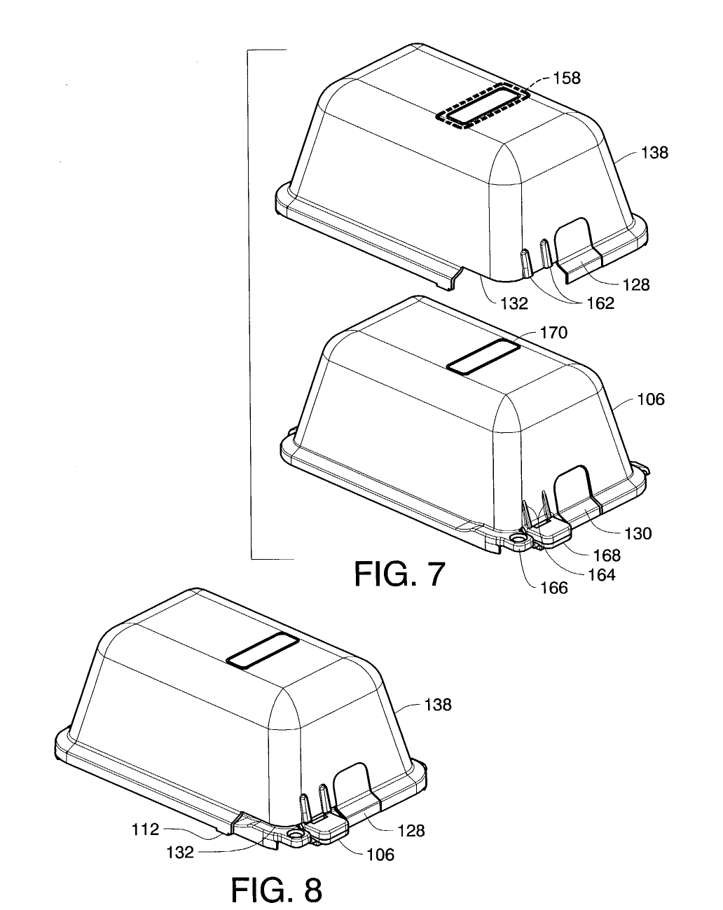

FIGS. 7 and 8 illustrate a further embodiment of the present invention. FIG. 7 illustrates a lid cover 138 separate from lid 106, while FIG. 8 illustrates a lid cover 138 releasably interlocked over lid 106. Lid cover 138 may further include one or more clearance slots 132 that may correspond to other components on lid 106, such as locking tab 166 that permits cover assembly to be selectively locked, and pull tab 168 that facilitates opening cover assembly 102. Pull tab 168 may be supported with structural ribs 164 that protrude from the exterior surface of lid 106 to distribute stress. As seen in FIG. 3, clearance slots 132 on lid cover 138 are recessed portions that provide clearance for structural ribs 164.

Referring still to FIGS. 7 and 8, the exterior of lid 106 may include one or more raised portions, such as embossed raised lettering of a logo 170. Corresponding in location, lid cover 138 may include one or more recesses 158 to accommodate raised portion 170. Alternatively, recess 158 may be a cut-out portion of lid cover 138 that permits logo 170 on lid 106 to be displayed through lid cover 138.

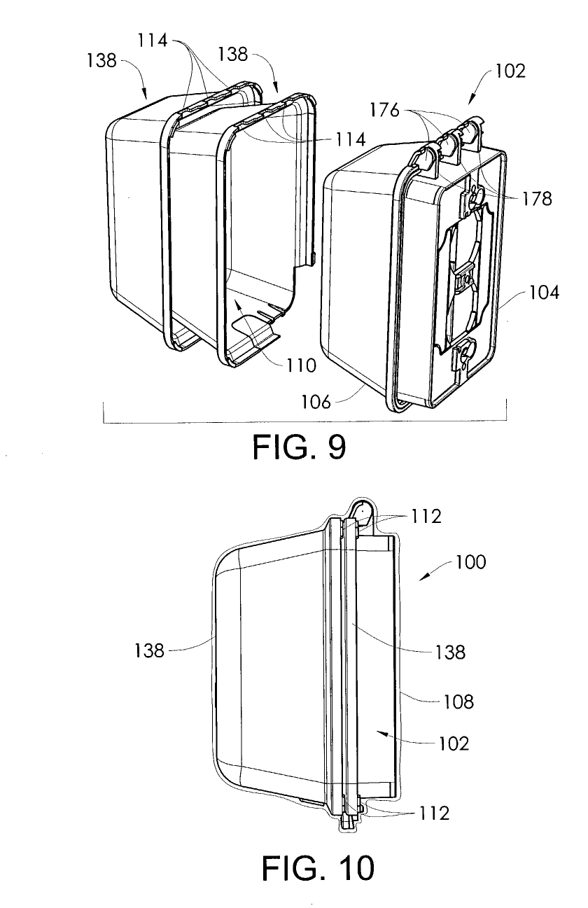

Referring now to FIG. 9, an embodiment of the present invention is further illustrated to show multiple lid covers 138 and an electrical outlet cover assembly 102. The tapered shape of the aperture or receptacle 110 of each lid cover 138 permits nesting of multiple lid covers 138 over an electrical outlet cover assembly 102 for packaging purposes.

Referring also to FIG. 10, an embodiment of the present invention is further illustrated to show multiple lid covers stacked over and packaged with an electrical outlet cover assembly. Package 100 includes a plurality of lid covers 138 and a cover assembly 102 surrounded by shrink wrap film 108. The innermost lid cover 138 may be interlocked with cover assembly 102 to reduce packing space. By including multiple lid covers 138 of different styles in a packaged cover assembly product 100, a consumer may interchange lid covers 138 and effectively customize the appearance of cover assembly 102. Further, by including multiple lid covers 138 of different styles in a packaged cover assembly product, purchasing and ordering may be simplified, due in part to a reduction in SKU's. Still further, by including multiple lid covers 138 of different styles in a packaged cover assembly product, shelf-space may be reduced.

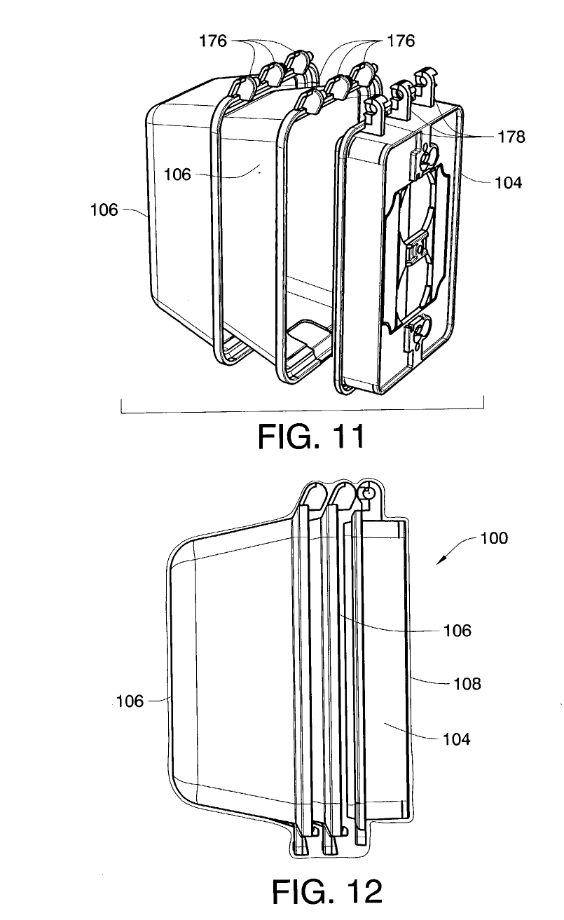

Referring now to FIG. 11, an alternate embodiment of the present invention is illustrated to show multiple lids and a base for an electrical outlet cover assembly. Instead of a lid cover, this embodiment includes multiple interchangeable lids 106, any of which may be attached to base 104 to form an electrical outlet cover assembly. Each lid 106 may have a different style and each may include hinge halves 176 that may be paired with hinge half mates 178 on base 104. By employing the lid 106 with the desired style to attach to base 104, the appearance of cover assembly 102 may be customized to the style of any lid cover 106.

Referring also to FIG. 12, an embodiment of the present invention is further illustrated to show multiple interchangeable lids 106 of different styles nested together and packaged with a base 104. Package 100 may include multiple lids 106 and a base 104 surrounded by shrink wrap film 108. By including multiple interchangeable lids 106 of different styles in a packaged cover assembly product 100, a consumer may choose the desired lid 106, thereby choosing the desired style for the cover assembly.

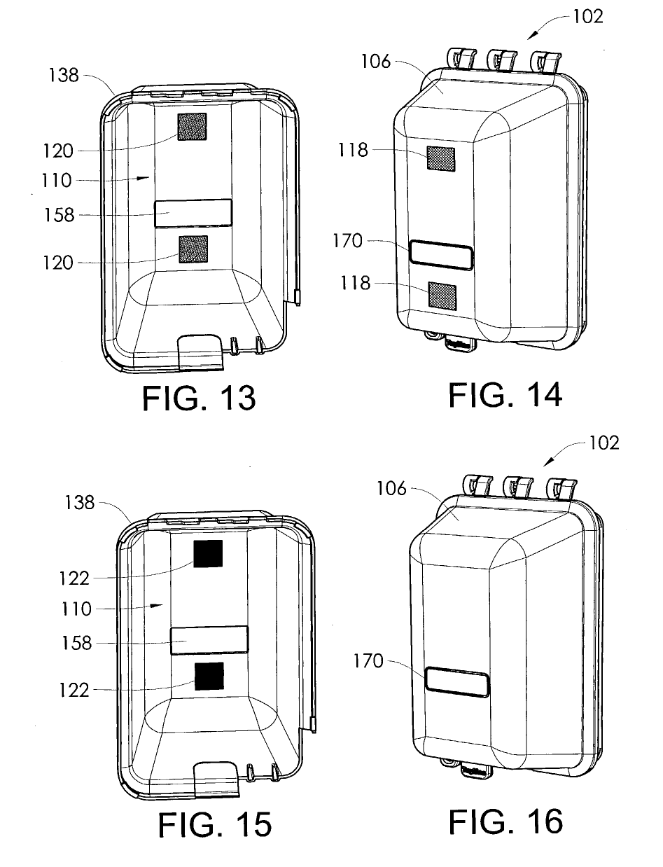

Referring now to FIGS. 13 and 14, a third embodiment of the present invention is illustrated to show a lid cover 138 and lid 106, respectively. The device that permits lid cover 138 to be attached to lid 106 in this embodiment may include hooking material 118, such as Velcro hooks, on lid 106, and loop material 120, such as Velcro loops, on lid cover 138. Alternatively, the hooking material may be located on lid cover 138 and the loop material on lid 106. The loop material and corresponding hooking material may be placed in any location on lid cover 138 and lid 106 to permit lid cover 138 to be releasably attached to lid 106, and to interlock lid cover 138 and lid 106.

Referring now to FIGS. 15 and 16, yet another embodiment of the present invention is illustrated to show a lid cover 138 and lid 106, respectively. The device that permits lid cover 138 to be attached to lid 106 in this embodiment may include adhesive strips 122 on lid cover 138 that may be employed to adhere lid cover 138 to lid 106. Alternatively, the adhesive strips 122 may be located on lid 106. More generally, the adhesive strips 122 may be placed in any location on lid cover 138 or lid 106 to permit lid cover 138 to be releasably attached to lid 106 and to interlock lid cover 138 and lid 106 together.

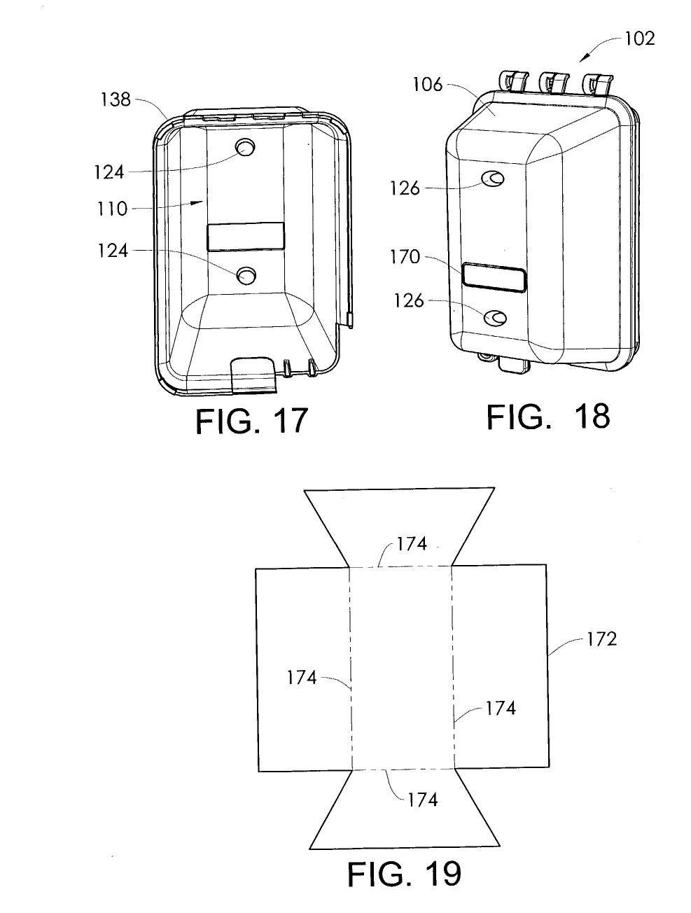

Referring now to FIGS. 17 and 18, another embodiment of the present invention is illustrated to show a lid cover 138 and lid 106, respectively. The device that permits lid cover 138 to be interlocked with lid 106 in this embodiment may include components that allow lid cover 138 to be attached to lid 106 with a press fit. For instance, lid cover 138 may include one or more male fittings of a suitable shape, such as tapered pins 124 and lid 106 may include one of more corresponding female fittings, such as tapered pinholes 126, that are capable to receive the tapered male thread. The tapered pins 124 and corresponding tapered pinholes 126 may be placed in any location of lid cover 138 and lid 106, respectively, to permit lid cover 138 to be releasably attached to lid 106 via a press fit and to interlock lid cover 138 and lid 106.

Lid cover 138 may alternatively include tapered holes, which may be employed with attach lid cover 138 to lid 106 with a suitable fastening mechanism, such as a screw. Lid cover 138 may also include other known types of male or female interlocking parts that allow it to be interlocked with lid 106.

Referring now to FIG. 19, a sixth embodiment of the present invention is illustrated to show a lid cover stencil 172. Lid cover stencil 172 may be employed as a pattern to cut out a lid cover for an electrical outlet cover assembly. Lid cover stencil 172 may be included in the packaging with an electrical outlet cover assembly. To form a lid cover from lid cover stencil 172, a flat piece of suitable material may be cut in the shape of stencil 172 and bent at fold lines 174 to cover lid 106. In this manner, the appearance of an electrical outlet cover assembly may be altered in appearance by the style of the material cut in the shape of stencil 172.

Accordingly, the invention advantageously provides the capability of customizing the appearance of an electrical outlet cover assembly while reducing SKU's. This advantage overcomes the disadvantages of requiring a SKU for each existing style of electrical outlet cover assembly. The invention also advantageously permits electrical parts suppliers to reduce the number of styles and retailers to reduce their ordering and stocking labor.

In the description herein, numerous specific details are provided, such as examples of rigid lid covers and examples of interlocking and attachment devices. One skilled in the relevant art will recognize, however, that the invention can be practiced without one or more of the specific details, or with other attachment methods, components, materials, and the like. For instance, a lid of a cover assembly may be manufactured of clear material and a lid cover of an alternate style may be attached to or interlocked with the interior of the clear lid such that the alternate style shows through and changes the appearance of the clear lid.

Another alternative embodiment may include a lid cover that is capable to cover the entire electrical outlet cover assembly and not just for the lid portion. Such a lid cover may include additional and deeper clearance slots for components that protrude from the exterior surface of the cover assembly, such as hinges, structural supports, logos, and the like.

A further alternative embodiment may include a lid manufactured with a lid cover that consists of multiple layers of peel-off color. The application of each layer of color may wrap around the exterior of the lid cover and extend to the interior of the lid cover. The edges of each color may be graduated to allow each color to be visible to the consumer, who may peel off outer colors until the desired lid cover style is reached.

Alternatively, the material employed for a lid cover may exist in a liquid state, such as a liquid plastic, which upon spray-on or other type of application to at least a portion of an electrical outlet cover assembly, hardens or dries to form a lid cover for the lid.

We claim:

1. An electrical outlet cover assembly comprising:
a lid;
a base;
a lid cover; and
interlocking means for interlocking the lid cover to the lid.

2. The electrical outlet cover assembly of claim 1, wherein:
said interlocking means comprises at least one finger on said lid cover and a rim on said lid.

3. An electrical outlet cover assembly comprising:
a base;
a lid;
a lid cover; and
wherein the lid interlocks with the lid cover.

4. An electrical outlet cover assembly comprising:
a first lid having at least one detachable hinge half;
a second lid having at least one detachable hinge half; and
a base having at least one detachable hinge half mate,
wherein the mate may be paired with either the at least one detachable hinge half of the first lid or the at least one detachable hinge half of the second lid.

5. An electrical outlet cover assembly comprising:
a base; and
a lid including a plurality of detachable coverings, each covering having a different style, wherein one or more of the plurality of coverings may be removed to expose one of the differing styles.

6. An electrical outlet cover assembly comprising:
a lid;
a base;
a lid cover; and
attaching means for attaching the lid cover to the lid.

7. The electrical outlet cover assembly of claim 6, wherein the attaching means is for releasably attaching the lid cover to the lid.

8. The electrical outlet cover assembly of claim 6, wherein the attaching means is for permanently attaching the lid cover to the lid.

9. An electrical outlet cover assembly comprising:
a lid;
a base;
a lid cover; and
attaching means for attaching the lid cover to the electrical outlet cover assembly.

10. A lid cover for an electrical outlet cover assembly comprising:
a receptacle; and
at least one attaching device connected to the receptacle, for attaching the lid cover to the electrical outlet cover assembly.

11. A lid cover stencil for an electrical outlet cover assembly that may be employed to permit a suitable material to be cut according to the shape of the stencil, and bent to form a lid cover for the electrical outlet cover assembly.

12. A lid cover for an electrical outlet cover assembly wherein:
the lid cover includes a first style,
the electrical outlet cover assembly includes a second style, and
the lid cover may be attached to the electrical outlet cover assembly to transform the second style into the first style.

13. A method of reducing stock keeping units for an electrical outlet cover assembly comprising:
packaging the electrical outlet cover assembly having a first style with a lid cover having a second style,
wherein the lid cover is capable to attach to the cover assembly to change the appearance of the cover assembly from the first style to the second style.

14. A method of reducing stock keeping units for an electrical outlet cover assembly comprising:
packaging a base for the electrical outlet cover assembly with a first lid having a first style and a second lid having a second style, wherein the first lid is capable to attach to the base to give the cover assembly the first style, and the second lid is capable to attach to the base to give the cover assembly the second style.

15. A method of reducing stock keeping units for an electrical outlet cover assembly comprising:
packaging the electrical outlet cover assembly having a first style with a lid cover stencil to allow the consumer to pattern a lid cover of a second style to fit onto the cover assembly.
